(19) United States
(12) Patent Application Publication
(10) Pub. No.: US 2013/0253100 A1
(43) Pub. Date: Sep. 26, 2013

(54) Omnidirectional Fracture Film and Process for Manufacturing Same

(71) Applicants: Robert D. Bailey, Long Beach, CA (US); Benjamin C. Tran, Warren, NJ (US); Frank F. Su, Cerritos, CA (US); Jack Randal Wilkerson, Umatilla, FL (US)

(72) Inventors: Robert D. Bailey, Long Beach, CA (US); Benjamin C. Tran, Warren, NJ (US); Frank F. Su, Cerritos, CA (US); Jack Randal Wilkerson, Umatilla, FL (US)

(21) Appl. No.: 13/429,064

(22) Filed: Mar. 23, 2012

(51) Int. Cl. C08L 25/06; B29C 35/10; B29C 47/00; C08K 3/26; C08K 3/34

(52) U.S. Cl. 524/35; 524/528; 524/427; 524/450; 524/76; 524/512; 264/210.1; 264/469

(57) ABSTRACT

Embodiments of the invention blend polyethylene (PE), polypropylene (PP), and polystyrene (PS) with calcium carbonate (CC) or other filler(s) to form a single or multi-layer plastic film. The result is an improved plastic film that retains the beneficial properties of conventional plastic films, but can also be easily fractured and creased. Embodiments of the invention also provide a method for manufacturing the single or multi-layer plastic film.

### BACKGROUND

1. Field of Invention

The invention relates generally to the field of plastics. In particular, but not by way of limitation, the invention relates to a plastic film having an omni-directional fracture characteristic and improved fold retention properties, as well as a process for manufacturing such a film.

2. Description of the Related Art

Many varieties of plastic films are known, including plastic films having polyethylene (PE) as their primary component. Plastic films are generally superior to paper sheeting for applications that require, for instance, a vapor or liquid barrier, superior strength, static cling, lint-free properties, and/or smooth bends. Plastic films may also be less expensive than paper sheeting. Conventional plastic films have disadvantages for some applications. For instance, known plastic films do not fracture (tear) easily or predictably. The ability to fracture plastic film may be desirable, for instance, for applications that require manual tearing for on-the-fly sizing or for compatibility with conventional paper die cutting equipment. In addition, plastic films, while creased and folded during their manufacturing process, typically are not conducive to additional creasing and fold retention after being made. An easy creasing and folding characteristic is desirable for many applications that require manipulating a sheet of plastic film to mimic or fit over a particular shape, for use in packaging, or facilitate dispensing by way of a fold over tab.

An improved plastic film that retains the beneficial properties of conventional plastic film, but can easily be fractured, creased, and folded, is therefore needed.

### SUMMARY OF THE INVENTION

Embodiments of the invention seek to overcome one or more of the limitations described above by blending multiple components to form a single or multi-layer plastic film.

In one embodiment of the invention, a plastic film includes: polyethylene (PE); polypropylene (PP); a filler, the filler including at least one of a rock-based mineral and a plant-based fiber; and polystyrene (PS), the plastic film being thus configured to fracture and crease more readily than a plastic film not including the filler. In embodiments of the invention, the filler may include, for instance, calcium carbonate (CC), zeolite, lignin, cellulosic fibers, and/or lignocellulosic fibers.

In another embodiment of the invention, a method for manufacturing a single-layer plastic film includes: receiving the PE, the PP, the filler, and the PS; mixing the PE, the PP, the filler and the PS to form a mix; blending the mix to form a blend; extruding the blend to form a tube; expanding the tube to form a bubble; quenching the bubble; and collapsing the bubble to form a web.

These and other features are more fully described in the detailed description section.

### BRIEF DESCRIPTION OF THE DRAWINGS

Embodiments of the invention are described with reference to the following drawings, wherein:

FIG. 1 is an illustration of a formula table for a plastic film, according to an embodiment of the invention;

FIG. 2 is an illustration of a list of alternative fillers for a plastic film, according to an embodiment of the invention;

FIG. 3 is a flow diagram of a process for manufacturing a plastic film, according to an embodiment of the invention;

FIG. 4 is a functional block diagram of a facility for manufacturing a plastic film, according to an embodiment of the invention; and

FIG. 5 is a schematic view of an extruder, according to an embodiment of the invention.

### DETAILED DESCRIPTION

Sub-headings are used in this section for organizational convenience; the disclosure of any particular feature(s) is/are not necessarily limited to any particular section or sub-section of this specification. The detailed description begins with a description of alternative formulae for the improved plastic film.

### Alternative Formulae

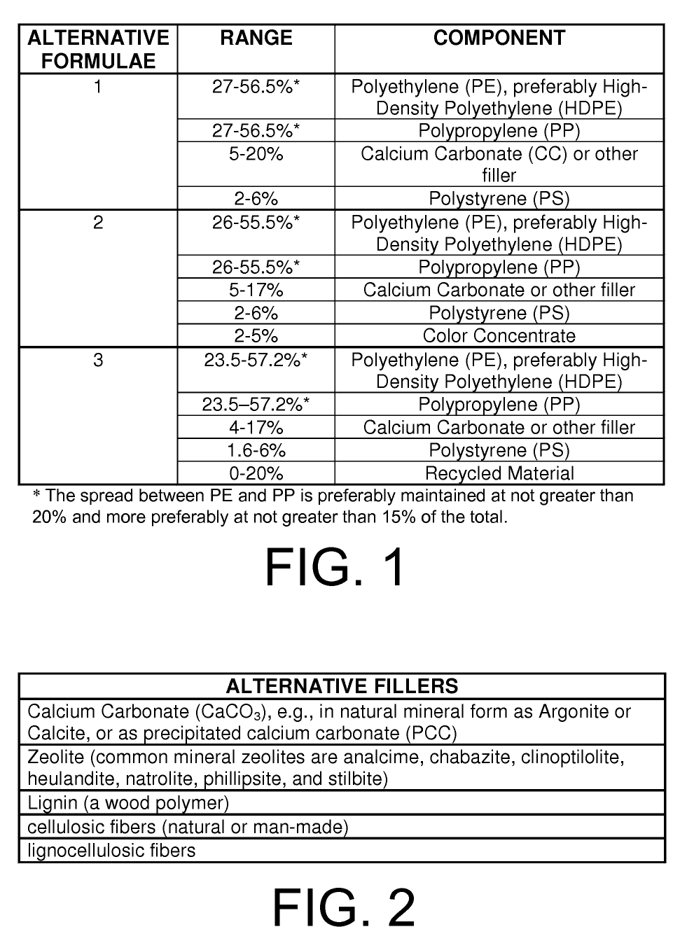

FIG. 1 is an illustration of a formula table for a plastic film, according to an embodiment of the invention. Alternative formula 1 illustrates an exemplary range of compositions for each constituent part. As shown, the ranges are 27-56.5% PE polyethylene (PE), 27-56.5% polypropylene (PP), 5-20% calcium carbonate (CC) or other filler, and 2-6% polystyrene (PS).

Alternative formula 2 illustrates an exemplary formula for a tinted film. As shown, the range for each component is 26-55.5% PE, 26-55.5% PP, 5-17% CC or other filler, 2-6% PS, and 2-5% color concentrate.

Alternative formula 3 illustrates an exemplary range of compositions based on having both virgin and recycled material. As shown, the range for each component is 23.5-57.2% PE, 23.5-57.2% PP, 4-17% CC or other filler, 1.6-6% PS, and 0-20% recycled material. The recycled material is made from scrap salvaged from earlier manufacturing runs or products of this same family and are made from a blend of raw materials that mirror the virgin component ratios typically used.

In each of the exemplary formulas, the PE is typically a film grade high density polyethylene (HDPE) resin. The PP is preferably film-grade polypropylene resin having a medium-to-high melt index. Exemplary alternative fillers are described below with reference to FIG. 2. The PS is a general purpose crystalline grade polystyrene resin. The filler minerals, color concentrates (where applicable), and other components are compounded into a concentrate using the PE resin.

Advantageously, in each of the above embodiments, the CC or other filler, and the PS, combine with the PE and PP to provide the desired fracture, creasing, and folding properties in the produced single or multi-layered film.

As noted in FIG. 1, the spread between PE and PP is preferably maintained at not greater than 20% and more preferably at not greater than 15% of the total. This preferred relationship between PE and PP has been determined empirically. As an illustration of this preferred restriction, consider the first alternative formula. If the filler component is 20% of the total and PS component is 6% of the total, then the PE and PP must combine for the remaining 74%. One possibility consistent with a 20% spread between the PE and PP would be PE at 27% and PP at 47%; another possibility would be PE at 47% and PP at 27%. If, however, the filler component is 5% of the total and the PS component is 2% of the total, then the PE and PP must combine for the remaining 93%. In this instance, one possibility consistent with the 20% spread would be PE at 56.5% and PP at 36.5%; alternatively, the components could be PE at 36.5% and PP at 56.5%. Maintaining the preferred spread between PE and PP produces a film with the desired properties. For instance, limiting the amount of PE limits the elongation property of the resulting film.

Variations in the formulas illustrated in FIG. 1 and described above are possible. For instance, any of the alternative formulas may further include 0-5% Polyoxymethylene (POM), a/k/a acetal, polyacetal, and polyformaldehyde, including either a POM homopolymer such as Delrin (a DuPont trade name), or a POM copolymer such as Celcon.

FIG. 2 is an illustration of a list of alternative fillers for a plastic film, according to an embodiment of the invention. Each of the listed fillers is a candidate for the formulas described above with reference to FIG. 1. Combinations of fillers listed in FIG. 2 are also candidates. Accordingly, the filler could be or include, for instance: Calcium Carbonate (CaCO₃), e.g., in natural mineral form as Argonite or Calcite, or as precipitated calcium carbonate (PCC); Zeolite (common mineral zeolites are analcime, chabazite, clinoptilolite, heulandite, natrolite, phillipsite, and stilbite); Lignin (a wood polymer); cellulosic fibers (natural or man-made); and/or lignocellulosic fibers. The addition of rock-based minerals (CC and/or Zeolite) and/or plant-based fibers (lignin, cellulosic fibers, and/or lignocellulosic fibers) modify the bulk physical properties of the plastic film.

### Manufacturing Process

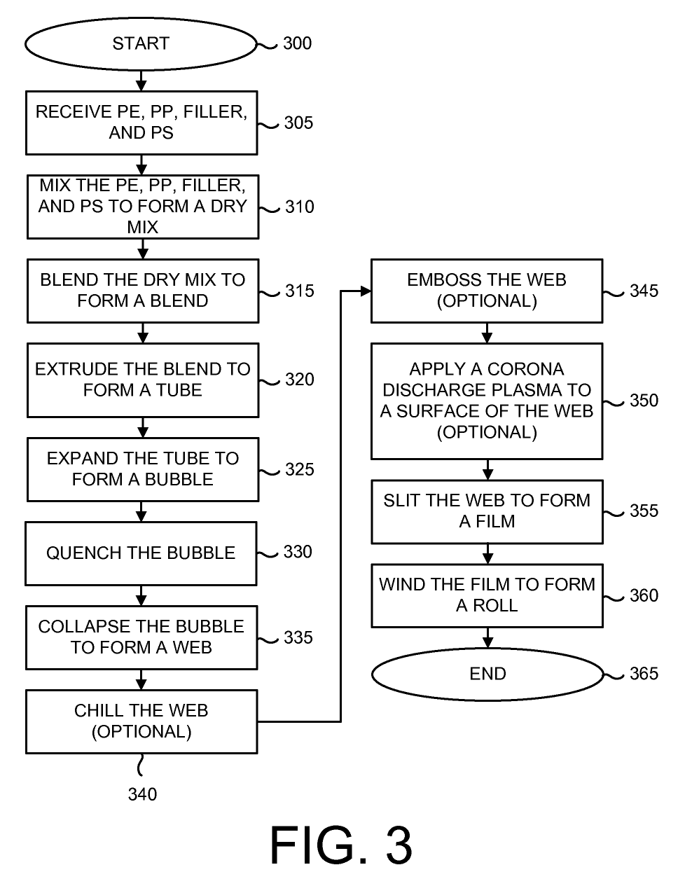

FIG. 3 is a flow diagram of a process for manufacturing a plastic film, according to an embodiment of the invention. As illustrated, after starting in step 300, the process receives all raw materials (e.g., PE, PP, filler, and PS) in step 305. The raw materials received in step 305 may also include recycled material, colorants, and/or other additives. Step 305 may include, for instance, loading pellets of each constituent component into one or more hoppers. The process then combines the raw materials in the desired ratios into a dry mixture in step 310. Next, in step 315, the process blends the dry mixture to form a relatively homogeneous blend in step 315.

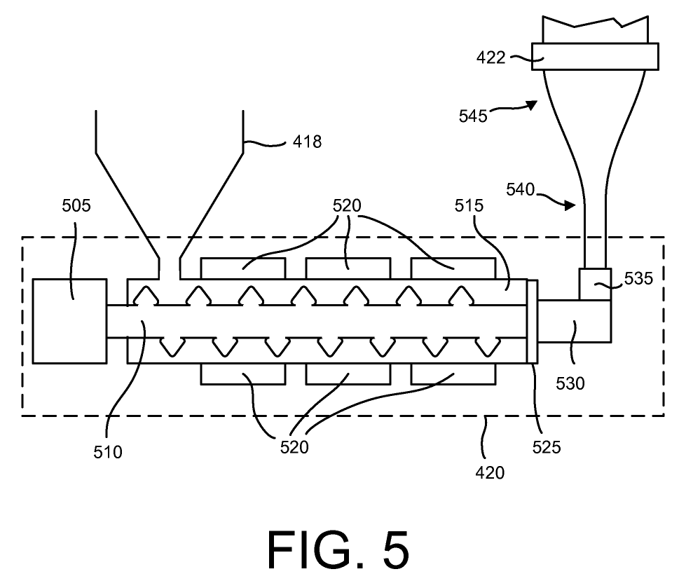

The process then extrudes the blend to form a tube in step 320. Extruding step 320 may include melting the blend, controlling the flow (metering) the blend during the melting, filtering the blend, and forcing the blend through a die to form the tube. An exemplary extruder configured to perform extruding step 320 is described below with reference to FIG. 5.

The tube is expanded into a bubble in step 325. Then, in step 330, the bubble is further conditioned by chilled air, preferably quenching the bubble to less than 100° F. The tube formed in step 320 preferably has a narrowed stalk of medium height, and the bubble formed in step 325 preferably has a standard blow up ratio used for HDPE films. Tube-forming step 320, bubble-forming step 325, and quenching step 330 minimize film tension and randomize the orientation of the polymer molecules in the bubble. The bubble is collapsed to form a web (a/k/a a collapsed bubble) in step 335, and the web may be further chilled in step 340. The purpose of optional chilling step 340 is to insure the non-uniform molecular orientation properties are set.

Embossing step 345 may be performed if required by for a specific application but it is not required to achieve the desired fracture and folding characteristics. The purpose of the embossing step 345 is to provide a surface texture for cosmetic purposes. A high level of corona discharge plasma may be applied to the exterior surfaces of the web in step 350, altering the surface of the film to optimize its wetting properties for later use in painting, spraying and/or printing operations. The web's edges are then slit (cut) and the remaining film may be further slit in step 355 to form a film of desired width. The process may also include winding the film to produce a roll of film in a predetermined length in step 360 before terminating in step 365.

The thickness of the resulting single-layer film may be, for instance, in the range of 7-250 μm and is preferably in the range of 30-75 μm.

Variations to the process illustrated in FIG. 3 are possible. For instance, chilling step 340 may not be required, and embossing step 345 is optional. Moreover, if, for instance, printing is not required, the corona treatment step 350 may be omitted. The process could also be modified to produce a multi-layer film rather than a single-layer film.

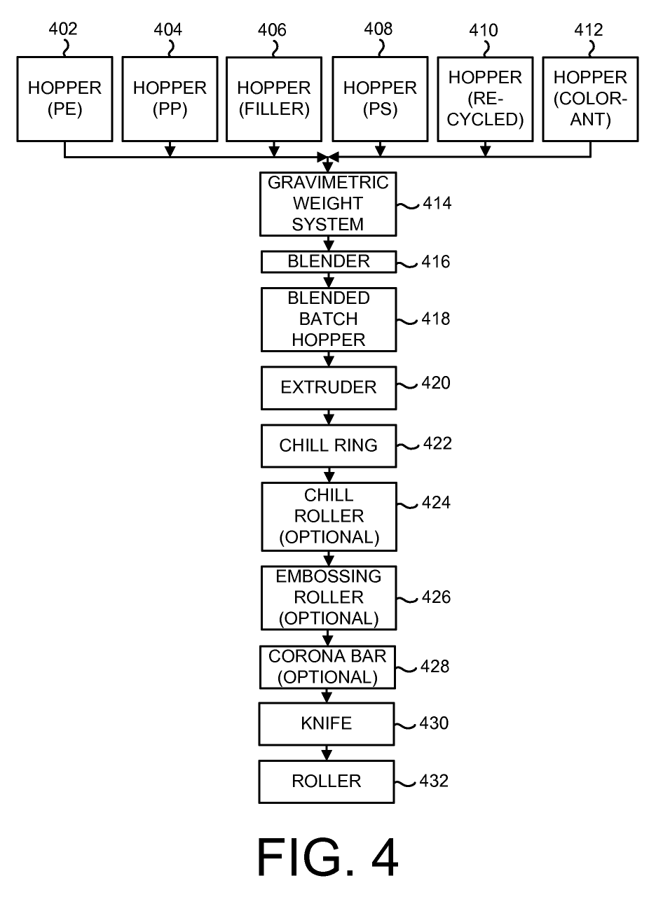

FIG. 4 is a functional block diagram of a facility for manufacturing a plastic film, according to an embodiment of the invention. The functional units illustrated in FIG. 4 may be used to perform the process described above with reference to FIG. 3.

In the illustrated embodiment, hoppers 402, 404, 406, 408, 410, and 412 receive and contain PE, PP, filler, PS, recycled material, and colorants, respectively. In embodiments of the invention, the same or additional hoppers could also include other additives (such as an anti-static agent). The foregoing constituents may be in pellet format. The gravimetric weigh system 414 is configured to perform mixing step 310 and the blender 416 is configured to perform blending step 315.

A blended batch hopper 418 is configured to store a blend at the input to the extruder 420. Various types of extruders 420 may be used to execute tube-forming step 320. An exemplary extruder 420 is described below with reference to FIG. 5.

The chill ring 422 is configured to perform quenching step 330. The chill roller(s) 424 are configured to perform collapsing step 335 and chilling step 340. In operation, the chill ring 422 and chill roller(s) 424 may be regulated, for example, at approx. 40-45 degrees F.

The embossing roller 426 and corona bar 428 are configured to perform the embossing step 345 and corona treatment step 350, respectively. The knife 430 is configured to perform slitting step 355. The roller 432 is configured to perform winding step 360.

Alternatives to the functional units illustrated in FIG. 4 are possible. For example, a different number of hoppers may be used according to the selected formula. Moreover, the chill roller(s) 424, embossing roller 426, corona bar 428, and/or roller 432 may not be required for some applications. Where chilling step 340 is omitted, a non-chilled roller(s) (not shown in FIG. 4) could be used to perform collapsing step 335. Moreover, such non-chilled rollers (not shown in FIG. 4) may be used in combination with the chill roller(s) 424, according to design choice.

FIG. 5 is a schematic view of an extruder 420, according to an embodiment of the invention. As shown therein, the extruder 420 includes a drive motor assembly 505 that is configured to turn a screw 510 within a barrel 515. The drive motor assembly 505 may include belts, gears, or other mechanical couplings (not shown) between a drive motor (not shown) and a shaft of the screw 510. Heaters 520 are disposed on an outer surface of the barrel 515. A filter 525, feedpipe 530, and forming die 535 are serially-coupled to an output of the barrel 515. The filter 525 may be or include, for instance, a screen filter.

In operation, a blend is received from the blended batch holder 418 into the barrel 515. The heaters 520 melt the blend into a liquid form. The screw 510 further mixes and advances the melted blend at a predetermined rate to an output end of the barrel 515, forcing the blend through the filter 525 feedpipe 530 and forming die 535 to form the tube 540. The tube 540 is conditioned, for instance using controlled air flow, to expand the tube 540 into the bubble 545. The chill ring 422 quenches the bubble.

Variations to the extruder configuration illustrated in FIG. 5 and described above are possible. For instance, in an alternative embodiment, the filter 525 may be disposed within the feedpipe 530 or coupled between the feedpipe 530 and the forming die 535. In a multi-layer film embodiment, two or more extruders 420 may feed co-extrusion tooling rather than separate forming dies 535.

### Experimental Results

The Inventors used the process illustrated in FIG. 3 and the functional units depicted in FIG. 4 to manufacture a test run of single-layer plastic film. A sample of the resulting material was analyzed to verify the constituents and corresponding relative composition. It was determined the sample contained 43.7% PE, 41.7% PP, 8.5% CC, 4.1% PS, and 2% colorant. Advantageously, the sample was relatively easy to fracture, manually, in any direction. The sample also retained a crease and was easy to fold. The material was 45μ in thickness. Measured film properties showed a drop impact of less than 20 grams, tear strengths under 10 grams, tensile strengths below 1500 psi, and elongation percentages below 100.

### SUMMARY

As described above, embodiments of the invention blend of PE, PP, CC or other fillers, and PS to form a single or multi-layer plastic film. The result is an improved plastic film that retains the beneficial properties of conventional plastic films, but can also be easily fractured and creased. Such films may be useful especially in applications such as paint masking and food packaging. Embodiments of the invention also provide a method for manufacturing the single or multi-layer plastic film.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms.

I claim:

1. A plastic film comprising:
polyethylene (PE);
polypropylene (PP);
a filler, the filler including at least one of a rock-based mineral and a plant-based fiber; and
polystyrene (PS), the plastic film being thus configured to fracture and crease more readily than a plastic film not including the filler.

2. The plastic film of claim 1, wherein the PE includes high-density polyethylene (HDPE).

3. The plastic film of claim 2, wherein at least a portion of the HDPE is recycled material.

4. The plastic film of claim 1, wherein a spread between a composition of the PE and a composition of the PP is not greater than 20%.

5. The plastic film of claim 1, wherein the filler includes calcium carbonate (CC).

6. The plastic film of claim 1, wherein the filler includes zeolite.

7. The plastic film of claim 1, wherein the filler includes lignin.

8. The plastic film of claim 1, wherein the filler includes cellulosic fibers.

9. The plastic film of claim 1, wherein the filler includes lignocellulosic fibers.

10. The plastic film of claim 1, wherein the plastic film includes:
between 27% and 56.5% of the PE;
between 27% and 56.5% of the PP;
between 5% and 20% of the filler; and
between 2% and 6% of the PS.

11. The plastic film of claim 1, wherein the plastic film includes:
between 26.5% and 55.5% of the PE;
between 26.5% and 55.5% of the PP;
between 5% and 17% of the filler;
between 2% and 6% of the PS; and
between 2% and 5% color concentrate.

12. The plastic film of claim 1, wherein the plastic film includes:
between 23.5% and 57.2% of the PE;
between 23.5% and 57.2% of the PP;
between 4% and 17% of the filler;
between 1.6% and 6% of the PS; and
between 0% and 20% recycled material, wherein the PE, the PP, the filler, and the PS are virgin materials and wherein the recycled material includes at least one of recycled PE, recycled PP, recycled filler, and recycled PS.

13. The plastic film of claim 1, further comprising Polyoxymethylene (POM).

14. A method for manufacturing the plastic film of claim 1, the method comprising:
receiving the PE, the PP, the filler, and the PS;
mixing the PE, the PP, the filler and the PS to form a mix;
blending the mix to form a blend;
extruding the blend to form a tube;
expanding the tube to form a bubble;
quenching the bubble; and
collapsing the bubble to form a web.

15. The method of claim 14, wherein the extruding includes:
melting the blend;
metering a flow of the blend during the melting;
filtering the blend; and
forcing the blend through a die to form the tube.

16. The method of claim 14, wherein the quenching reduces a temperature of the bubble below 100 degrees F.

17. The method of claim 14, further comprising chilling the web using a chilled roller.

18. The method of claim 14, further comprising embossing the web.

19. The method of claim 14, further comprising applying a corona discharge plasma to a surface of the web.
